(19) United States
(12) Patent Application Publication
(10) Pub. No.: US 2004/0207805 A1
(43) Pub. Date: Oct. 21, 2004

(54) Protective eyewear having removable nose bridge and adjusting eye pieces

(76) Inventors: Mark A. Chovan, Frisco, TX (US); Todd Wheeler, Plano, TX (US)

Correspondence Address: Michael F. Krieger, Kirton & McConkie, Suite 1800, 60 East South Temple, Salt Lake City, UT, 84111, US

(21) Appl. No.: 10/675,330

(22) Filed: Sep. 30, 2003

Related U.S. Application Data
(60) Provisional application No. 60/463,798, filed on Apr. 18, 2003.

(51) Int. Cl. G02C 5/02

(52) U.S. Cl. 351/124

(57) ABSTRACT

The present invention features protective eyewear comprising first and second eyepieces formed of uniform material that is substantially impervious to light, wherein the first and second eyepieces each comprise an opaque eye cup and a transparent ultraviolet light blocking lens integrally formed with the eye cup to create or provide a unitary eye cup/lens combination; and a nose bridge removably coupled to each of the first and second eyepieces via an attachment means that may also be a dynamic attachment means that facilitates vector positioning of the eyepieces about the nose bridge for a more customized, ergonomically correct fit of the protective eyewear for multiple users.

### RELATED APPLICATIONS

The present invention relates to U.S. Provisional Patent Application No. 60/463,798, filed, Apr. 18, 2003, and entitled, “Protective Eyewear with Removable Bridge.”

### BACKGROUND

1. Field of the Invention

The present invention relates to protective eyewear, and particularly to protective eyewear used for tanning in natural or artificial light environments.

2. Background of the Invention and Related Art

It is generally recognized that many people are quite concerned with their overall appearance, yet are equally concerned about their safety. This is evident from the popular interest in safely obtaining a deep tan.

As a result, there has been a significant growth in tanning products, including protective eyewear designed to be used primarily in tanning. Frequently, many sunbathers have a strong tendency to lie in the sun or in tanning beds that produce artificial ultraviolet light for lengthy periods with their eyes closed without applying any protective sunscreens to the eyelids. As such, this exposes their sensitive eyelids to the harmful, burning rays of ultraviolet light. In addition, while tanning under artificial light it is often important to allow the user to open his or her eyes to see the control of the tanning bed or to exit the room. The individual's eyes must be protected from UV exposure during these activities. As such, protective eyewear is available with lenses that block ultraviolet light, thus protecting the eyes, yet still allow the user to open his or her eyes if necessary.

Many prior art protective eyewear have been designed to shield the eyes from ultraviolet light. However, prior art protective eyewear often leaves the wearer with unsightly tan lines across the nose and/or brow area where the nose bridge rests.

### SUMMARY AND OBJECTS OF THE INVENTION

In light of the deficiencies in the prior art set forth above, the present invention seeks to improve prior art protective eyewear, and particularly protective eyewear designed to protect the user from ultraviolet light exposure during tanning in artificial or natural environments.

Therefore, it is an object of some embodiments of the present invention to provide protective eyewear that comprises a removable nose bridge, thus allowing the user to wear the protective eyewear with or without the nose bridge.

It is another object of some embodiments of the present invention to provide protective eyewear with a removable nose bridge that does not contact the user and eyepieces that are substantially impervious to UV light and that are made from a single, uniform material.

It is still another object of some embodiments of the present invention to provide protective eyewear with a removable nose bridge that allows the brow area of the user to receive exposure to ultraviolet light.

It is a further object of some embodiments of the present invention to provide protective eyewear having dynamic, adjusting eye pieces that accommodate different anatomical sizes and shapes of various individuals.

Other objects not specifically recited herein may be obvious to one ordinarily skilled in the art and are intended to be covered by the present invention.

In accordance with the invention as embodied and broadly described herein, the present invention generally features dual-purpose protective eyewear comprising first and second eyepieces formed of uniform material that is substantially impervious to UV light. The protective eyewear further comprises an optional nose bridge that is removably coupled to the top of each of the first and second eyepieces, wherein the nose bridge comprises an elevated rise that reduces or eliminates blockage of light. The protective eyewear is dual purpose in that they may be worn with the nose bridge attached to the eyepieces, or without the nose bridge, wherein the individual wears just the separate eyepieces.

In one exemplary embodiment, first and second eyepieces each comprise an opaque eye cup and a see-through lens that is integrally formed with the eye cup to form a unitary eye cup/lens combination, and wherein the eye-cups block ultraviolet light. In this embodiment, the user is only allowed to see through the lenses, as the eye cups are opaque.

In another exemplary embodiment, first and second eyepieces each comprise a transparent or semi-transparent eye cup that is substantially impervious to UV light, and a see-through lens that is integrally formed with the eye cup to form a unitary eyepiece or eye cup/lens combination, and wherein the entire eyepieces are designed to block UV light. In this embodiment, the portion or segment of the eye cup not considered the lens allows visible light to penetrate there through, thus allowing the user to see through the eye cups.

The present invention protective eyewear further features a nose bridge connected to the top surface of the eyewear, wherein the nose bridge has an elevated rise that connects each eyepiece together and wherein the nose bridge comprises a given elevation so that when the protective eyewear is worn, the nose bridge does not come in contact with the nose or brow area of the user. Building elevation into the nose bridge has several advantages. For instance, the eyewear is more comfortable to wear because the nose bridge does not contact the skin of the user, and is therefore less irritating than other designs. Furthermore, providing an elevated rise further functions to reduce blockage of light or shadowing caused by the nose bridge when tanning because the light is able to sufficiently travel beneath the nose bridge, thus exposing the nose or brow area to ultraviolet light.

The nose bridge may be made of opaque material that blocks all light, of semi-translucent material that allows an identified amount of light (both ultraviolet and visible light) there through, or completely translucent, thus allowing as much light as is possible there through.

The bridge is also removable from the eyepieces, thus allowing the user to remove the nose bridge altogether and particularly before a tanning session when it is desired to maximize exposure to the sun or an artificial light source. The nose bridge may be removably coupled to each eyepiece using any known attachment means in the art. In one exemplary embodiment, a joint similar to a dovetail joint is utilized where each eyepiece slides or snaps onto the nose bridge.

The present invention further features adjusting eye pieces. In one embodiment, the attachment means used to attach each eyepiece to the nose bridge is a dynamic attachment means that ensures or facilitates a pre-determined amount of movement between each eyepiece and the nose bridge, wherein each eyepiece is allowed to move a certain amount or distance, preferably in any degree of freedom (also known and referred to herein as vector movement). This vector movement is accomplished by providing a loose fitting attachment between each eyepiece and the nose bridge.

The present invention further features a method for protecting the eyes during tanning while minimizing light blockage caused by the bridge of protective eyewear, as well as a method for creating protective eyewear having eyepieces with integrally formed eyecup/lens combination, a removable nose bridge, and adjusting eyepieces.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a perspective view of the protective eyewear and the nose bridge as removed from one eyepiece according to one exemplary embodiment of the present invention;

FIG. 2 illustrates a perspective view of the protective eyewear and the nose bridge as removably coupled to each eyepiece according to one exemplary embodiment of the present invention;

FIG. 3 illustrates a detailed view of one exemplary connection means used to couple the nose bridge to each eyepiece.

FIG. 4 illustrates a front view of the assembled protective eyewear according to one embodiment of the present invention; and

FIG. 5 illustrates a top view of the assembled protective eyewear according to one embodiment of the present invention.

### DETAILED DESCRIPTION OF THE PREFERRED EMBODIMENTS

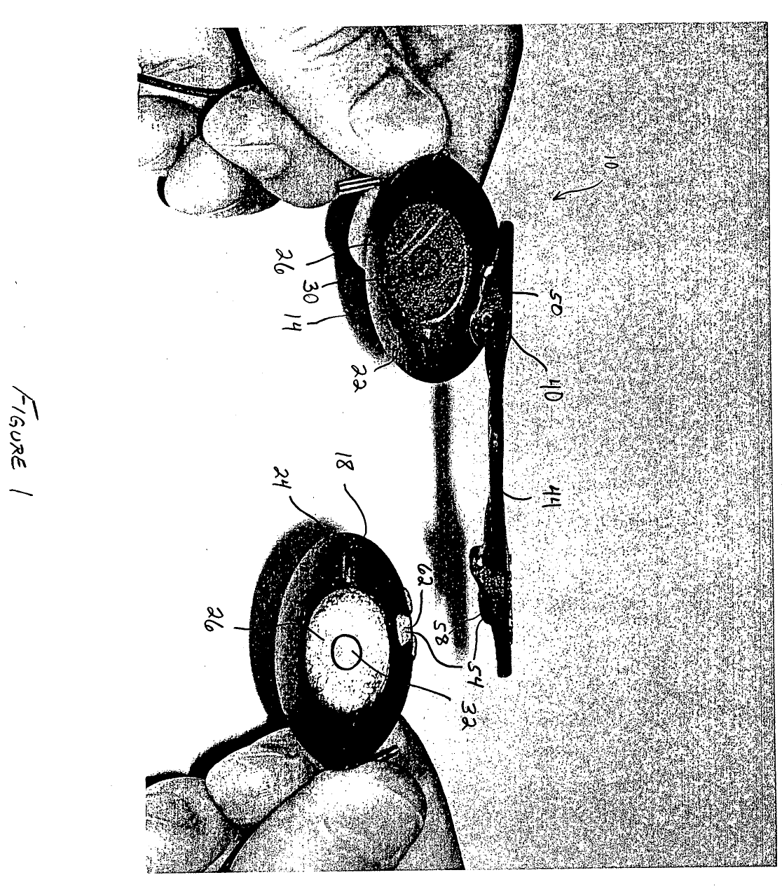

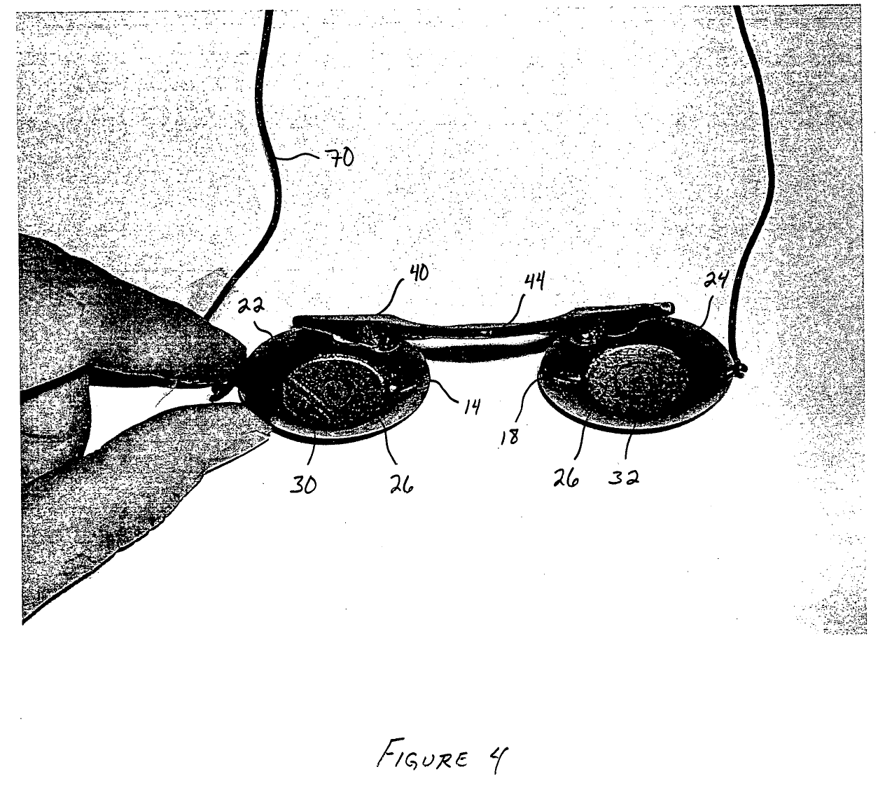

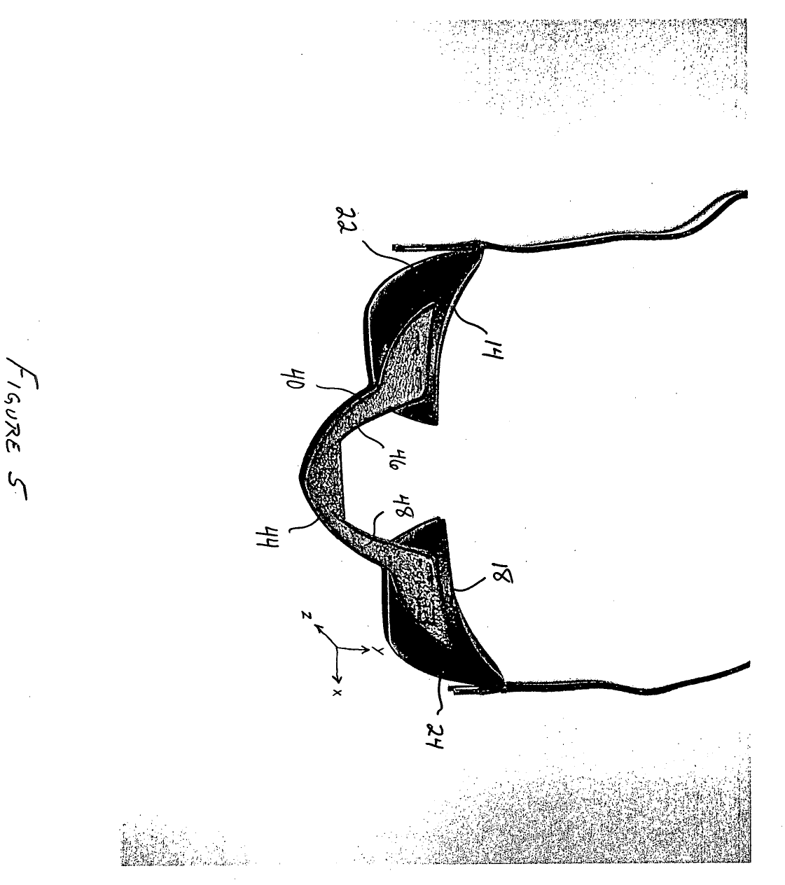

It will be readily understood that the components of the present invention, as generally described and illustrated in the figures herein, could be arranged and designed in a wide variety of different configurations. Thus, the following more detailed description of the embodiments of the system and method of the present invention, and represented in FIGS. 1 through 5, is not intended to limit the scope of the invention, as claimed, but is merely representative of the presently preferred embodiments of the invention.

The presently preferred embodiments of the invention will be best understood by reference to the drawings wherein like parts are designated by like numerals throughout.

The present invention describes protective eyewear having lenses integrally formed with an eye cup, an optional nose bridge having an elevated rise that is removably attached or coupled to first and second eyepieces, and eyepieces that are either opaque, transparent, or semi-transparent, that are made of a single, uniform material so as to comprise a unitary eye cup/lens combination, and that are impervious or substantially impervious to light or that are translucent to visible light.

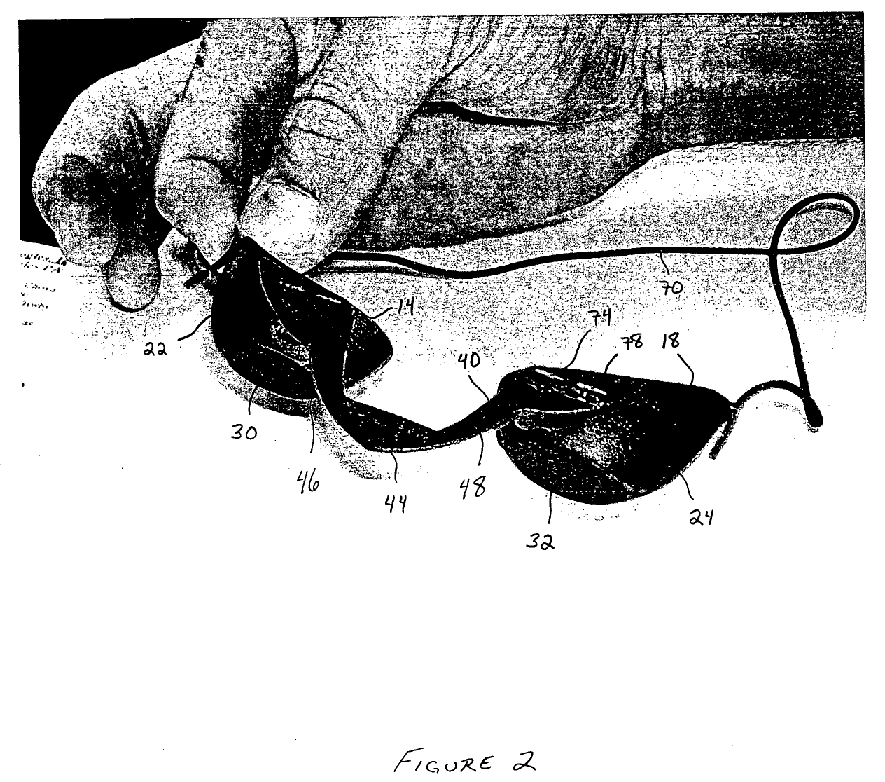

With reference to FIGS. 1 and 2, protective eyewear 10 generally comprises a first eyepiece 14, a second, complimentary eyepiece 18, a nose bridge 40 that removably attaches or couples to first and second eyepieces 14 and 18 and that comprises an extended or elevated rise 44 that ensures nose bridge 40 has no contact with the user, and a flexible head band 70 that removably attaches to first and second eyepieces 14 and 18. FIG. 1 illustrates protective eyewear 10 in the configuration or arrangement in which nose bridge 40 is removed from second eyepiece 18. FIG. 2 illustrates protective eyewear having nose bridge 40 attached thereto.

In the illustration in FIG. 1, eyepiece 18 is detached from nose bridge 40, thus illustrating the detachable relationship between eyepieces 14 and 18 and nose bridge 40. As can be seen, nose bridge 40 is removably coupled to eyepieces 14 and 18 and achieves this using one or more types of attachment means. As such, nose bridge 40 functions as an optional element of protective eyewear 10 where protective eyewear 10 can be worn with or without the nose bridge 40, thus making protective eyewear 10 dual functional.

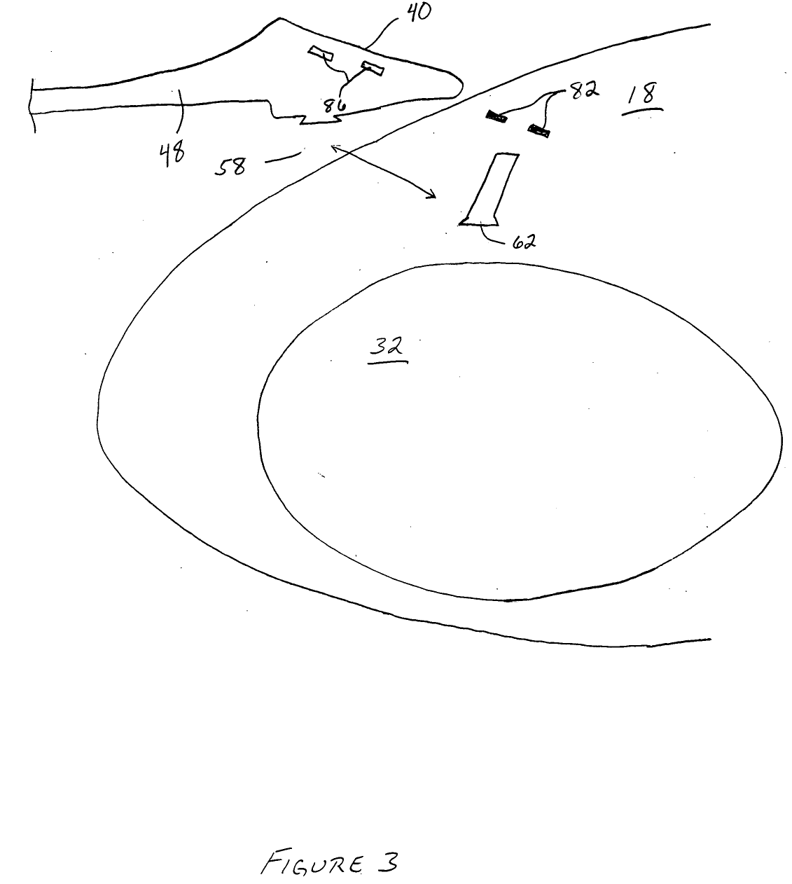

In one preferred, yet exemplary embodiment, shown in FIG. 3, nose bridge 40, and particularly supports 46 and 48, is/are attached to eyepieces 14 and 18 using an attachment means comprising an arrangement similar to a dovetail joint configuration, wherein the male and female segments of the dovetail joint are formed within either nose bride 40 or eyepieces 14 and 18. In the embodiment shown in FIGS. 1 and 3, nose bridge 40 comprises the male segment 58 of a dovetail joint at each respective point of attachment. Nose bridge 40 is attached to first eyepiece 14 at first attachment point 50 and to second eyepiece 18 at attachment point 54 by inserting male segment 58 into the corresponding receiving female segment 62 located on each respective eyepiece 14 and 18. This configuration functions to temporarily secure nose bridge 40 to each of eyepieces 14 and 18. Moreover, the fit between male and female segments 58 and 62, or rather the relationship between eyepieces 14 and 18 and nose bridge 40, is designed to be snug so that eyepieces 14 and 18 will not inadvertently detach from nose bridge 40.

Attachment means may also comprise first and second stabilizers 74 and 78 (see FIG. 3) located on each eyepiece 14 and 18. Stabilizers 74 and 78 may be used to stabilize the attachment of nose bridge 40 to eyepieces 14 and 18, especially in light of the preferred embodiment in which eyepieces 14 and 18 are allowed to move or adjust about the attachment means due to the loose fit designed into the attachment of nose bridge 40 to eyepieces 14 and 18, which is discussed in greater detail below.

In one exemplary embodiment, stabilizers 74 and 78 comprise an extension 82 that fits into an aperture or receiver 86. In the embodiment shown, extensions 82 are located on the top of each eyepiece 14 and 18, and apertures 86 are located on nose bridge 40, such that apertures 86 receive extensions 82 upon connection or attachment of nose bridge 40 to eyepieces 14 and 18. Once attached, stabilizers 74 and 78 function to ensure or maintain the integrity of the attachment means. As will be obvious to one of ordinary skill in the art, stabilizers 74 and 78 may comprise many different designs, configurations, etc., each fulfilling the function of stabilizing the attachment means used to attach nose bridge 40 to eyepieces 14 and 18, as well as to ensure eyepieces 14 and 18 are not allowed to move about the attachment means and nose bridge 40 to a degree greater than intended.

Nose bridge 40 may be attached at any location or point on eyepieces 14 and 18, but is preferably attached at or near the top of eyepieces 14 and 18. Attaching nose bridge 40 to the top or top surface of eyepieces 14 and 18 provides several advantages. For instance, by attaching nose bridge 40 to the top of eyepieces 14 and 18, supports 46 and 48 of nose bridge 40 may be spaced further apart or provide for increased support separation than prior art designs where the supports attach along the inner sides of the eyepieces. Increased support separation allows more light to pass beneath each of the supports and rise 44 to provide greater tanning exposure around the nose or brow area of the user, or to decrease blockage of ultraviolet light caused by wearing protective eye wear 10.

To further prevent inadvertent detachment, various securing means may be implemented to improve the attachment of eyepieces 14 and 18 to nose bridge 40. Any securing means known in the art may be used, with one such embodiment comprising a ridge configuration or design, such as that employed to temporarily secure a lid to a pen.

Although a dovetail joint has been specifically recited above as the means used for coupling or attaching eyepieces 14 and 18 to nose bridge 40, it is anticipated that other attachment means may be employed as commonly known in the art and as will be recognized by one skilled in the art. One such attachment means may comprise a snap configuration, wherein nose bridge 40 and eyepieces 14 and 18 comprise complimentary elements that snap together. Another attachment means may comprise a flexible member having an aperture therein that is attached to nose bridge 40 that fits over or receives a peg-like element there through that is located on eyepieces 14 and 18. Indeed, several attachment means are contemplated herein.

Head band 70 secures eyewear 10 to the user's head to provide a more secure and snug fit, as well as helping to keep the eyepieces together or becoming lost if the removable bridge is detached.

The present invention removable nose bridge provides several advantages over prior art protective eyewear in which the nose bridge is fixed or stationary. First, and perhaps most compelling, during tanning it is desirable to minimize blocking of either natural or artificial light from various objects, such as clothing, sunglasses, hair, etc. in order to be able to receive maximum exposure to such light and to prevent unwanted tan lines, while still protecting the eye and eyelids from harmful ultraviolet light. This is especially true with respect to the face and surrounding areas since these areas receive more attention as being the most noticeable to others. Being able to selectively remove or detach the nose bridge from the protective eyewear allows the user to eliminate a potential block to natural or artificial light and to employ only the eyepieces while still protecting the sensitive eye area.

Second, a removable nose bridge provides the user with the above mentioned option, while still enabling the user to couple the eyepieces together using the nose bridge when upon completion of the tanning session for more easy manipulation and handling of the protective eyewear, as well as to more easily keep track of each component.

Third, if the nose bridge is left intact and attached to each of the eyepieces during a tanning session, the increased separation of the supports of the nose bridge, coupled with the extended or elevated rise, function to minimize blockage of natural or artificial light caused by the nose bridge. The above advantages should not be considered limiting in any way, as other advantages not specifically recited herein will be apparent to one ordinarily skilled in the art.

The present invention further features an elevated or extended nose bridge. FIGS. 1-5 illustrate nose bridge 40 as it further comprises rise 44 that extends from each of eyepieces 14 and 18 in an upward manner and across the brow or nose of the user. Nose bridge 40, and particularly rise 44, is designed to be substantially elevated above the brow area of the user so that there is no contact with any part of the user's body, particularly the nose or brow area, while still maintaining a low profile design to reduce shadowing or shadowing effects often encountered during tanning that are typically created by protective eyewear. Providing an elevated rise helps to ensure that the skin around the nose and brow area receives maximum exposure to natural or artificial light when protective eyewear 10 is being worn by the user. As such, rise 44 is a no-contact rise. As described above, the increased separation of supports 46 and 48, by being attached to the top of eyepieces 14 and 18, also contributes to a reduction in shadowing, and helps ensure maximum exposure to natural or artificial light.

Providing an elevated rise also provides maximum comfort as the only portion of protective eyewear 10 that contacts the user is eye cups 22 and 24. As such, there is less of protective eyewear 10 that can rub against and irritate the skin of the user as opposed to prior art designs.

In one embodiment, nose bridge 40 may be comprised of opaque material that blocks all ultraviolet and visible light from passing there through. In another embodiment, nose bridge 40 may be comprised of translucent or semi-translucent material that allows an identified amount of both visible and ultraviolet light to pass there through. Providing a nose bridge made of translucent or semi-translucent material allows the user to attach the nose bridge without increasing blockage of ultraviolet light. in other words, the nose bridge allows ultraviolet light to pass there through and to contact the skin surface of the individual that would otherwise be blocked if the nose bridge was impervious to ultraviolet light.

With reference to FIGS. 1-4, eyepieces 14 and 18 comprise eye cups 22 and 24, respectively, and lenses 30 and 32. Lenses 30 and 32 are comprised of see-through material that is capable of blocking or filtering ultraviolet light, thus protecting the wearer's eyes from the harmful radiation of ultraviolet light, but allowing enough visible light there through to still allow the user to see through lenses 30 and 32. Lenses 30 and 32 are designed to be utilized in either natural or artificial light environments, and are substantially impervious to visible light. Lenses 30 and 32 are preferably made of Lexan™ material produced by General Electric or other material that provides ultraviolet blockage, durability, strength, and optical clarity.

Eyepieces 14 and 18 are comprised of a single, unitary structure. In other words, eyepieces 14 and 18 comprise a single, unitary lens/eye cup combination, wherein each of eye cups 22 and 24 and lenses 30 and 32 are comprised of and formed from the same material. In this way, lenses 30 and 32 are defined and formed from eye cups 22 and 24. As such, eyepieces 14 and 18 are preferably comprised, in their entirety, of material that blocks ultraviolet light in order to provide lenses that are unitary with the eye cups, but that are still able to block ultraviolet light.

Many prior art designs comprise two separate pieces or component parts that couple together to form the eyepiece, namely an opaque eye cup having an opening that receives and supports a lens therein that is substantially impervious to light.

Unlike these prior designs, the present invention comprises a unitary piece that functions similar to prior art designs, without requiring a lens to be secured within an eyecup as a separate piece. As described above, the present invention eyepieces comprises first and second eye cups 22 and 24 having respective lenses 30 and 32 therein, wherein lenses 30 and 32 are integrally formed within and/or made of the same semi-transparent material as eye cups 22 and 24.

In one exemplary embodiment, eyepieces 14 and 18 are formed entirely of material that is substantially impervious to light, or semi-transparent, but wherein the material blocks ultraviolet light. However, eye cups 22 and 24 are opaque so that the wearer may only see through lenses 30 and 32. Eye cups 22 and 24 are made opaque using one or more means known in the art. One exemplary method comprises texturing in the mold to a portion of eyepieces 14 and 18 to form and define eye cups 22 and 24, as well as lenses 30 and 32, which are left untouched. Texturing the semi-transparent material in a given area thus makes that area opaque. Eye cups 22 and 24 are opaque by texturing a defined portion of eyepieces 14 and 18. Lenses 30 and 32 are not textured and create a defined area on front face 26 that is smooth and transparent. Since the material used for eyepieces 14 and 18 was substantially impervious to UV light and were constructed of an ultraviolet blocking material lenses 30 and 32 within eyepieces 14 and 18 are essentially created or formed. Lenses 30 and 32 may be defined to comprise any size or geometry as desired.

In another embodiment, eye cups 22 and 24 are transparent, or semi-transparent to allow the wearer to see through both lenses 30 and 32, as well as eye cups 22 and 24. Eye cups 22 and 24 and lenses 30 and 32 may each comprise different visible light blocking properties. For example, lenses 30 and 32 may be made with higher light blocking properties than eye cups 22 and 24 as the lenses are more proximate to the eye. Or, lenses 30 and 32 may be made to allow the user to see better out of the lenses than the eye cups.

Protective eyewear 10 further includes a head band 70 adapted to fit around the head of a user. Head band 70 is formed of an elastic material capable of expanding and contracting to retain eyepieces 14 and 18 in position over the eyes of the user while tanning. Head band 70 is designed to accommodate the differences in head sizes from user to user, and is preferably removably secured to the eyepieces 14 and 18. Head band 70 is dual functional in that it first functions to secure protective eyewear to the user during use, and second, to couple eyepieces 14 and 18 together when nose bridge 40 is removed so that they remain together.

The present invention further features adjusting eyepieces. In one embodiment, the attachment means used to attach eyepieces 14 and 18 to nose bridge 40 is made to allow or provide a pre-determined amount of movement between eyepieces 14 and 18 and nose bridge 40, such that each eyepiece is allowed to move a certain amount or distance, preferably in any degree of freedom (also known and referred to herein as vector movement) with respect and while attached to nose bridge 40. This vector movement is accomplished by providing a loose fitting attachment between eyepieces 14 and 18 and nose bridge 40. Indeed, once attached, eyepieces 14 and 18 adjust with respect to nose bridge 40 by moving in any degree of freedom. Eyepieces 14 and 18 may be allowed to move any distance along one vector as desired. This feature allows protective eyewear 10 to adjust to many different sizes and shaped wearers, thus improving the ergonomics of protective eyewear 10. However, in one preferred embodiment, eyepieces 14 and 18 are allowed only slight movement, impeded by the attachment means itself. Stated differently, the attachment means used to couple eyepieces 14 and 18 to nose bridge 40 is designed to facilitate movement of the eyepieces with respect to the nose bridge. This may be accomplished in any number of ways. In the embodiment shown in the Figures, the dovetail-like joint is formed to comprise larger female portion or receiver, such that an initial barrier of entry (e.g., a snap or snap-like segment) must be overcome to attach nose bridge 40 to eyepieces 14 and 18, but that once this initial barrier is overcome and the male portion of the joint received by the female portion of the joint, the male portion is allowed to move more freely about or within the female portion in any direction, only impeded or restricted by the edges of the joint. Thus, as protective eyewear 10is worn, the wearer may adjust eyepieces 14 and 18 as needed to achieve a more comfortable fit.

The present invention further features a method for protecting the eyes during tanning while minimizing light blockage caused by wearing protective eyewear comprising the steps of obtaining protective eyewear having first and second eyepieces and an optional removable nose bridge, wherein the nose bridge comprises an elevated rise; placing the first adjusting eyepiece on a first eye of an individual before a tanning session; placing the second adjusting eyepiece on the other eye of the individual before the tanning session. The method further comprises the step of attaching the removable nose bridge to the eyepieces and placing the coupled protective eyewear on the individual, as well as the step of removing the nose bridge before tanning, if desired, to eliminate all blocking of light to the nose and brow area that might be caused by wearing protective eyewear. The method further comprises the step of reattaching the nose bridge as desired upon completion of the tanning session.

The present invention further features a method of manufacturing protective eyewear designed to be worn during a tanning session in either natural or artificial light, wherein the method comprising the steps of: shaping and forming first and second eyepieces; defining a lens portion and an eye cup portion on each of the eyepieces, wherein the lens portion blocks ultraviolet light; integrally forming the lens portion with the eye cup portion to create a uniform eyepiece having a unitary eye cup/lens combination; forming a nose bridge and removably attaching the nose bridge to the first and second eyepieces via attachment means, wherein attachment means facilitates vector positioning of the eyepieces about the nose bridge to provide a customized and ergonomically correct fit on various wearers. The removable nose bridge further comprises first and second supports and an elevated rise that minimizes blockage of ultraviolet light from the eye, nose, and brow area of the wearer.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. Protective eyewear comprising:
first and second eyepieces formed of uniform material, wherein said first and second eyepieces each comprise an eye cup and a lens integrally formed with said eye cup to comprise a unitary eye cup/lens combination; and
a nose bridge removably coupled to each of said first and second eyepieces via an attachment means, said nose bridge comprising first and second supports and an elevated rise that reduces blockage of ultraviolet light from the nose and brow area of a wearer when attached.

2. The protective eyewear of claim 1, wherein said attachment means is a dynamic attachment means that facilitates limited independent, pre-determined adjusting and vector movement of said eyepieces to provide a customized fit for a more comfortable and ergonomically correct fit.

3. The protective eyewear of claim 1, wherein said eye cups are impervious to ultraviolet light.

4. The protective eyewear of claim 1, wherein said eye cups are substantially impervious to ultraviolet light.

5. The protective eyewear of claim 1, wherein said eye cups are translucent to allow an identified amount of visible light to pass there through.

6. The protective eyewear of claim 1, wherein said eye cups comprise one or more colors.

7. The protective eyewear of claim 1, wherein said lenses comprise varying shades of tint.

8. The protective eyewear of claim 1, wherein said nose bridge is made of translucent material that allows ultraviolet light to penetrate there through, thus further reducing blockage of ultraviolet light from the nose and brow area of said wearer.

9. The protective eyewear of claim 1, wherein said nose bridge is attached to a top surface of said eyepieces to improve attachment and reduce blockage of ultraviolet light.

10. Protective eyewear comprising:
a first eyepiece having an eyecup and an integrally formed lens to comprise a unitary eye cup/lens combination;
a second eyepiece having an eyecup and an integrally formed lens;
a removable nose bridge having first and second supports that extend from a top surface of each of said first and second eyepieces and attach to said top surface via attachment means, respectively, and an elevated rise connecting said first and second supports a distance above the nose and brow area of a user to reduce blockage of ultraviolet light.

11. The protective eyewear of claim 10, wherein said attachment means is a dynamic attachment means that facilitates independent limited vector movement of said first and second eyepieces, thus allowing said protective eyewear to ergonomically adjust to said wearer and also different wearers, as well as providing a more comfortable, customized fit.

12. The protective eyewear of claim 10, wherein said first and second eyepieces are comprised of transparent material capable of blocking ultraviolet light.

13. The protective eyewear of claim 10, wherein said first and second eyepieces are comprised of semi-transparent material capable of blocking ultraviolet light.

14. The protective eyewear of claim 10, wherein said first and second eyepieces are comprised of opaque material that blocks ultraviolet light.

15. The protective eyewear of claim 10, wherein said nose bridge is comprised of translucent material capable of allowing ultraviolet light to pass there through.

16. The protective eyewear of claim 10, wherein said nose bridge is comprised of semi-translucent material capable of allowing ultraviolet light to pass there through.

17. The protective eyewear of claim 10, wherein said nose bridge is comprised of opaque material that is capable of blocking ultraviolet light.

18. Protective eyewear comprising:
a first eyepiece having an eyecup and an integrally formed lens;
a second eyepiece having an eyecup and an integrally formed lens, said first and second eyepieces, and particularly said eye cups and said lenses, formed of uniform material;
a nose bridge removably fittable with said eyepieces and having first and second supports, and an elevated rise connecting said first and second supports a distance above the nose and brow area of a user to reduce blockage of ultraviolet light;
attachment means for connecting said nose bridge to a top surface of said first and second eyepieces.

19. The protective eyewear of claim 18, wherein said attachment means is a dynamic attachment means that facilitates customized, limited, and independent vector positioning and movement of said first and second eyepieces about said nose bridge to provide a more ergonomically correct fit to one or more wearers.

20. A method of protecting the eyes of an individual during a tanning session, said method comprising the steps of:
obtaining protective eyewear comprising:
first and second adjusting eyepieces formed of uniform material, wherein said first and second eyepieces each comprise an eye cup and a lens integrally formed with said eye cup;
placing said first adjusting eyepiece on an eye of said individual before a tanning session;
placing said second adjusting eyepiece on the other eye of said individual before a tanning session.

21. The method of claim 20, further comprising the step of adjusting said first and second eyepieces to obtain a more ergonomically correct and comfortable fit.

22. The method of claim 20, further comprising the step of attaching a nose bridge to said first and second eyepieces via an attachment means that facilitates independent vector movement of each of said eyepieces with respect to said nose bridge, said nose bridge comprising supports and an elevated rise connecting said supports, said elevated rise reducing blockage of ultraviolet light from the nose and brow area of said individual.

23. The method of claim 22, further comprising the step of independently adjusting said eyepieces relative to said nose bridge via said adjustment means to obtain a more ergonomically correct and comfortable fit.

24. The method of claim 22, further comprising the step of removing said nose bridge from said eyepieces as desired.

25. A method of manufacturing protective eyewear designed to be worn during a tanning session in either natural or artificial light, said method comprising the steps of:
shaping and forming first and second eyepieces;
defining a lens portion and an eye cup portion on each of said eyepieces, said lens portion blocking ultraviolet light;
integrally forming said lens portion with said eye cup portion to create a uniform eyepiece having a unitary eye cup/lens combination;
attaching a removable nose bridge to said first and second eyepieces via attachment means, wherein attachment means facilitates vector positioning of said eyepieces about said nose bridge to provide a customized and ergonomically correct fit on various wearers, said removable nose bridge comprising first and second supports and an elevated rise.
